(19) United States
(12) Patent Application Publication
(10) Pub. No.: US 2016/0306876 A1
(43) Pub. Date: Oct. 20, 2016

(54) SYSTEMS AND METHODS OF DETECTING INFORMATION VIA NATURAL LANGUAGE PROCESSING

(71) Applicant: Metalogix International GmbH, Schaffhausen (CH)

(72) Inventors: Gabriel Nichols, New York, NY (US); Daniel Adamec, New York, NY (US)

(73) Assignee: Metalogix International GmbH, Schaffhausen (CH)

(21) Appl. No.: 15/092,478

(22) Filed: Apr. 6, 2016

Related U.S. Application Data
(60) Provisional application No. 62/144,306, filed on Apr. 7, 2015.

(51) Int. Cl. G06F 17/30; G06N 99/00; G06N 7/00

(52) U.S. Cl. CPC G06F 17/30705; G06F 17/30011; G06F 17/30684; G06F 17/30675; G06N 7/005; G06N 99/005

(57) ABSTRACT

The disclosure is related to systems and methods of detecting information via natural language processing. A processing system can be configured to perform natural language processing on a selected set of documents and detect information in the documents. The information may be based on binary questions identified by a client, such as personally identifiable information. The natural language processing can be performed using statistical models, such as frequency analysis, hidden Markov models, or neural networks.

### CROSS REFERENCE TO RELATED APPLICATIONS

The present application is a non-provisional of and claims priority to U.S. Provisional Patent Application Ser. No. 62/144,306, filed Apr. 7, 2015 and entitled “SYSTEMS AND METHODS OF DETECTING INFORMATION VIA NATURAL LANGUAGE PROCESSING”, the entirety of which is incorporated by reference herein for all purposes.

### SUMMARY

In certain embodiments, a system may include a network interface configured to send data to a client, memory configured to store the data and store a software module, and a controller configured to execute the software module to perform a method. The method may include performing natural language processing on a selected set of documents, detecting selected information in the documents, and alerting the client about the selected information via the network interface.

In certain embodiments, a method may include performing natural language processing on a selected set of documents, detecting selected information in the documents, and alerting the client about the selected information via the network interface. The method may implement natural language processing using statistical models, such as frequency analysis, hidden Markov models, or neural networks, in any combination or order.

In certain embodiments, a memory device may store instructions that, when executed, cause a processor to perform a method. The method may include performing natural language processing on a selected set of documents and detecting selected information in the documents. In addition, other devices, systems, and processes are described herein.

### BRIEF DESCRIPTION OF THE DRAWINGS

FIG. 1 is a diagram of a system of detecting information, in accordance with certain embodiments of the present disclosure;

FIG. 2 is a flowchart of a process of detecting information, in accordance with certain embodiments of the present disclosure;

FIG. 3 is a flowchart of a process of corpus development, in accordance with certain embodiments of the present disclosure;

FIG. 4 is a flowchart of a process of model training, in accordance with certain embodiments of the present disclosure;

FIG. 5 is a diagram of a system of detecting information, in accordance with certain embodiments of the present disclosure;

FIG. 6 is a flowchart of a process of content analysis, in accordance with certain embodiments of the present disclosure;

FIG. 7 is a diagram of a system of categorizing a content analysis result, in accordance with certain embodiments of the present disclosure;

FIG. 8 is a diagram of a system of content analysis, in accordance with certain embodiments of the present disclosure;

FIG. 9 is a flowchart of a process of content analysis, in accordance with certain embodiments of the present disclosure;

FIG. 10 is a diagram of detection levels in a process of content analysis, in accordance with certain embodiments of the present disclosure;

FIG. 11 is a flowchart of a process of job results for a content analysis system, in accordance with certain embodiments of the present disclosure;

FIG. 12 is a diagram of a graphical user interface (GUI) in a system of detecting information, in accordance with certain embodiments of the present disclosure; and

FIG. 13 is a diagram of a graphical user interface (GUI) in a system of detecting information, in accordance with certain embodiments of the present disclosure.

### DETAILED DESCRIPTION

In the following detailed description of the embodiments, reference is made to the accompanying drawings which form a part hereof, and in which are shown by way of illustrations. Features, functions, and elements of the various figures, embodiments, and examples herein may be combined or exchanged. Further, other embodiments may be utilized and structural changes may be made without departing from the scope of the present disclosure. Even further, features, functions, or elements of the various figures, embodiments, and examples herein can be removed without departing from the scope of the present disclosure.

In accordance with various embodiments, the processes, methods, and functions described herein may be implemented as one or more software programs running on a computer system with a processor or controller device. In accordance with various embodiments, the methods and functions described herein may be implemented as one or more software programs running on a computing device, such as a computer server or a system of computer servers. Further, the processes, methods, and functions described herein may be implemented as a device, such as a computer readable storage medium or memory device, including instructions that when executed cause a processor to perform the processes, methods, and functions.

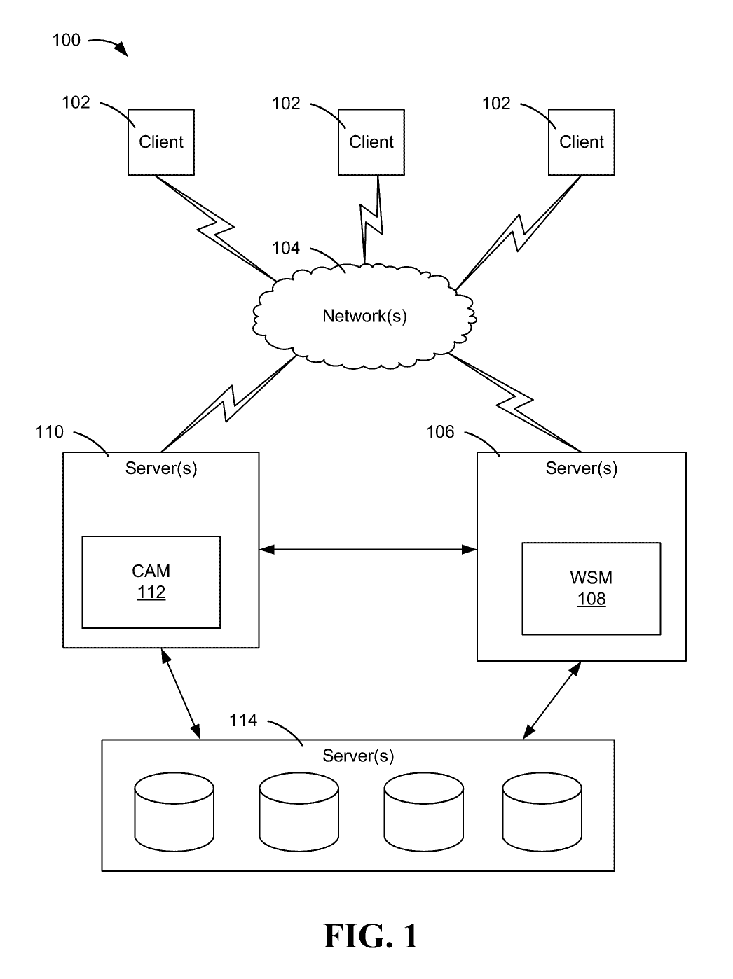

Referring to FIG. 1, a system of detecting information, in accordance with certain embodiments of the present disclosure, is shown and generally designated 100. The system 100 can include content analysis server 110, which may be configured to implement and execute a content analysis module (“CAM”) 112. The content analysis server 110 may be communicatively coupled to a workflow service server 106, which may be configured to implement and execute a workflow service module (“WSM”) 108. Examples of workflow service software module 108 include web application platforms, such as Microsoft's SharePoint or other software that provides intranet portals, document and file management, collaboration, social networks, process and workflow capabilities, or any combination thereof.

The content analysis server 110 may be communicatively coupled to a data storage server 114 and to a network 104, such as a internet, intranet, or other communication network. The workflow service server 106 may also be coupled to the data storage server 114 or to a different data storage server, and may also be coupled to the network 104 or a different network.

During operation, a client 102 may communicate with the content analysis server 110 or the workflow service server 106, via the network 104 or other means, to indicate one or more documents should be examined to determine whether the document(s) include certain content. The workflow service module 108 may add a job to a job queue based on a request from a client 102 to analyze a selected set of documents. The workflow service module 108 may then initiate the content analysis module 112 to perform content analysis on the selected set of documents.

Automatically determining (i.e. without human interaction and without human determination) certain content within a document can be difficult, especially when there is a large collection of documents. For example, businesses store massive amounts of documents which contain content that has a variety of different types of information in them which do not conform to simple patterns. However, the content analysis module 112 provides a method to determine what types of content are stored in what documents, and can be used for a single document or a large collection of documents.

The content analysis module 112 can use a variety of techniques in natural language processing to perform binary classification against a list of predefined questions. The content analysis module 112 can build a score for each document by weighing the frequency of occurrence of positive results/examples of the questions and weights for each question in a specified content type. For example, if the content analysis module 112 is trained to detect personally identifying information the questions can determined if the following exist in a document: name, address, email address, phone number, government identification number, financial account information, date of birth, other information in context with which an individual without specialized expertise would be able to identify an individual, or any combination thereof.

To determine whether a document includes certain information represented by a binary question (e.g. having a binary result, such as a yes or no answer), each question can be given a weight and the each document is scored based on the number of incidences of detected results of each question and their weights with the scores then being placed into ranges indicating a level of detection for the specific document. The scores may be translated to an indicator for a client 102 to communicate whether no information was detected, mild amount of information was detected, a moderate amount of information was detected, or a severe amount of information was detected; other indicators may be used as well. The detection results, scores or indicators of a detection level may be transmitted to the client or elsewhere.

The client 102 may interface with a GUI to initiate a document or set of documents to be examined, to view the status of a job request, or to view the results of a job, as well as perform other functions described herein. The GUI may interface with the workflow service server 106 (or the content analysis server 110 or both) to receive data corresponding to the documents, indications of the status of a job request, indications of the results of a job, or any combination thereof.

The content analysis module 112 may include these three components: corpus development, model training, and file analysis. While all three of these components will be discussed herein, one will recognize that not all of these components need to be implemented on the same server, at the same time, or at the same place. For instance, corpus development, model training, or both may be done separately from a server implementing a resulting model for file analysis.

Further, the content analysis module 112 may include implementing one or more statistical models to determine the contents of a document or file. For example, the content analysis module 112 may include a frequency analysis model, a hidden Markov model, a neural network model, or any combination thereof. In certain embodiments, the content analysis module 112 may implement a frequency analysis model, a hidden Markov model, and a neural network model to perform content analysis on each document.

For example, content text for each document can be run against (i.e. processed via) frequency analysis models (e.g. there may be a model corresponding to each question) and first results can be computed; the first results may be compared to a minimum threshold and a maximum threshold. For any questions where the first results fall between the minimum threshold and the maximum threshold, the content text can be run against (i.e. processed via) the hidden Markov models to calculate second results. For any questions where both the first results and the second results are between the fall between the minimum threshold and the maximum threshold, the content can be run through (i.e. processed via) the neural networks and a value of the output neurons can be determined to provide third results. The first results, second results, and third results may be used to determine the level of answer to the questions, which may include no information detected, mild amount of information detected, a moderate amount of information detected, or a severe amount of information detected. However, if all three results return values are between the minimum threshold and the maximum threshold, the answers to the questions may be ambiguous, and the content can be indicated or marked as “unable to identify”, or similar, indicating that detection of the information was undetermined.

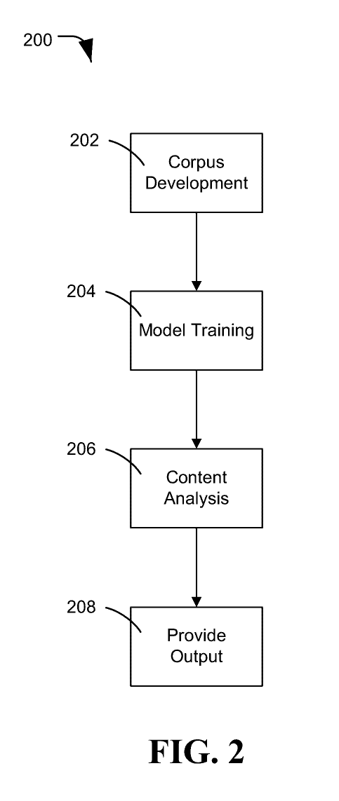

Referring to FIG. 2, a flowchart of a process of detecting information, in accordance with certain embodiments of the present disclosure, is shown and generally designated 200. The process 200 may include corpus development, at 202, model training, at 204, and content analysis, at 206. The process 200 may be performed by the system 100 or any other of the systems described herein; for example, the process 200 may be implemented by content analysis module 112.

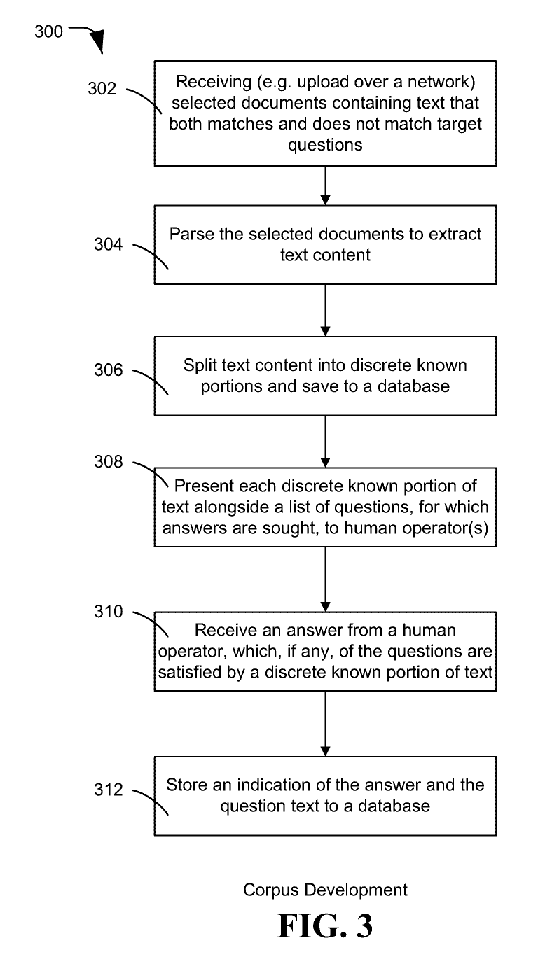

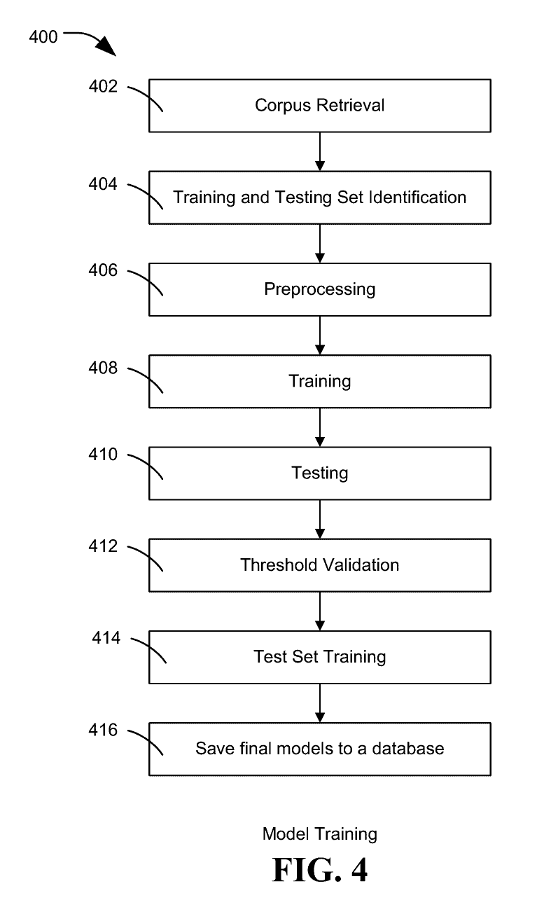

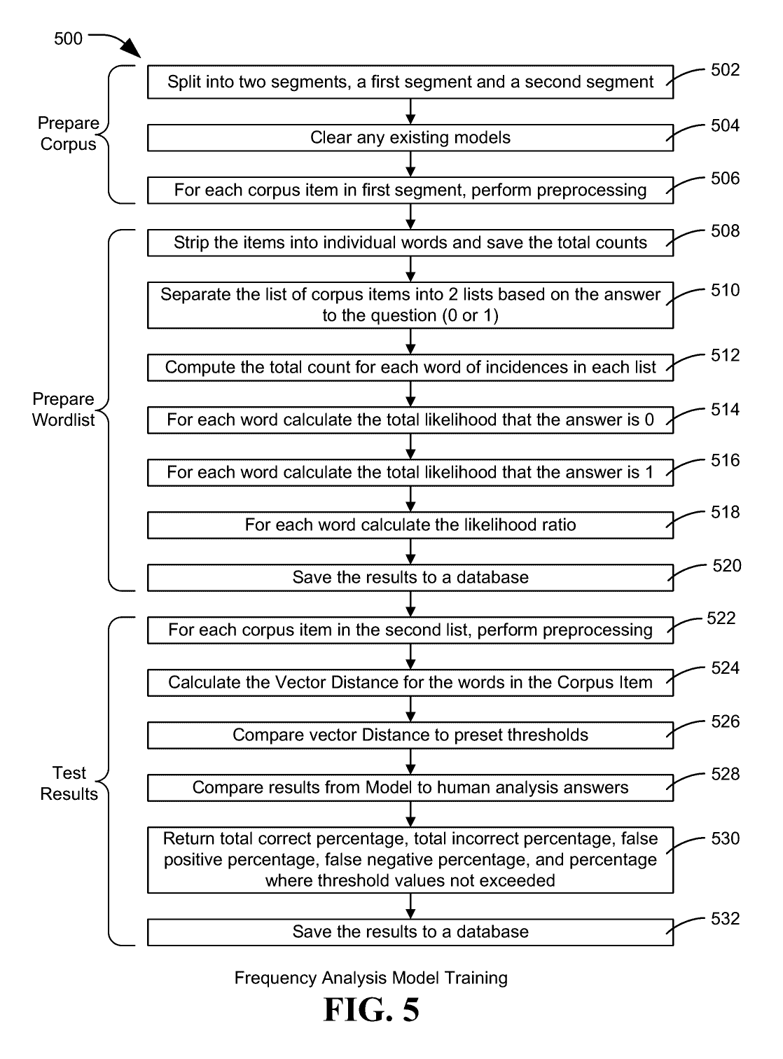

As described above, the corpus development, model training, and content analysis may be done at a server or may be done at separate servers. Further details of the corpus development, model training, and content analysis will be discussed with respect to FIG. 3, FIG. 4, and FIG. 5, respectively, as well as other figures discussed herein.

Referring to FIG. 3, a flowchart of a process of corpus development, in accordance with certain embodiments of the present disclosure, is shown and generally designated 300. The corpus development process 300 may be part of the process 200 and may be implemented by the system 100 or any other of the systems described herein.

The corpus development process 300 may include receiving a selection of documents containing text that both matches and does not match one or more specific binary questions, at 302. A binary question is a question that only has a possibility of two answers, such as a yes or no answer. After receiving the documents or files, they can be parsed and text content can be extracted, at 304. The text content can be split into discreet known chunks (such as defined by a size amount or a format, such as paragraph indicator) and saved in a database, at 306.

Human operators (e.g. analysts) can then be presented with each chunk of text alongside a list of the specific questions for which answers are being sought (e.g. specific content), at 308, and the human operators can identify which, if any, of the questions the presented text contains, at 310. An indicator of the human operator's answers can be saved to a database along with the question text, at 312. In some examples, distinct pieces of information may be stored, including a pointer to the location of the content text, a pointer to the question text, and the answer. If a human operator is uncertain about an answer to a question, they can be presented with an option to skip a given piece of text content and move on to the next piece of text content.

In some embodiment, an entire byte stream of uploaded documents can be saved to a database and presented to a human analyst in a native format viewer. A native format viewer can be the software application that works with the format of a specific file during creation, editing, or publication of the file. The analysts may use a customized menu, such as accessible by a right click of a computer mouse, to select specific text which provides an answer to one or more of the questions that are being analyzed. Upon selecting text and confirming a question, the selected text and an index location in the file can be saved to a database. When an analyst confirms all questions have been reviewed for a file, the entire text of the file can be extracted and also saved.

Referring to FIG. 4, a flowchart of a process of model training, in accordance with certain embodiments of the present disclosure, is shown and generally designated 400. The model training process 400 may be part of the process 200 and may be implemented by the system 100 or any other of the systems described herein.

When a usable corpus has been developed or otherwise exists, such as after enough answers are provided on a critical mass of questions, model training can be performed to build statistical models. In some embodiments, the statistical models can include models developed along three distinct mathematical computations.

The model training process 400 can include retrieving a relevant corpus from data storage, such as a database, at 402. All corpus items with answers recorded for a specific question can be retrieved from the database, which may be in a random order. Data retrieval can be separated into batches to maximize memory efficiency; further, the order of data retrieval may be random to help avoid training sequentially on large quantities of data from a single source.

Further, the model training process 400 can include identifying a training set of data and a test set of data, at 404. For example, the corpus items may be split into two sets. For example, ninety percent (90%) of the corpus items with answers recorded for a specific question can be selected as the training set with the remaining 10% selected as the test set.

Once the training set and the test set are selected, the model training process 400 may perform preprocessing, at 406. During preprocessing, each corpus item can be filtered through a number of preprocessing steps, such as spelling check, replacing known patterns with identifiers through regular expression checking (e.g. a regular expression may be a client defined expression), stripping special characters, converting all words to lowercase, or any combination thereof. In some embodiments, for neural networks, the words can be replaced with 300 dimensional vectors calculated using the Glove algorithm from Stanford OpenNLP Project including a random vector defined for unknown words not in the database.

After the preprocessing, the model training process 400 may perform training, at 408. New empty models can be initialized using random starting criteria and then saved to a database. Then, the training set can be retrieved and separated into batches of predetermined size (e.g. the default batch size can be 10,000 items). Training can be performed sequentially on the batch items, at the end of which the data can be saved back in the database (or elsewhere). Batches can be run until all the training items have been processed.

In some embodiments, after each batch of training items, models can be saved and the models can be tested. After testing completes, an accuracy indicator (e.g. a value expression) of the model can be saved. Training can then be run on another batch and the testing can occur after the another batch is trained. Such a cycle of training and testing can continue until the results (e.g. accuracy indicator) of the tests no longer improve, indicating that the model has begun to overfit (e.g. models which are trained so heavily on specific content that they do not generalize well to new content), at which point a saved model from an immediately preceding previous training batch can be retrieved and presented as the final trained model. If all of the training items have been processed through the training before the models stop improving, the training can start again on the first batch of items.

When the training has completed, the model training process 400 may perform testing, at 410. However, the training and testing may be combined as described above. During testing, the test set can be retrieved from the database and separated into batches of predetermined size (e.g. a default batch size can be 10,000 items). Each item in a batch can be processed in parallel through the analysis methods using the models created and updated during the training phase. At the end of each batch, the item identifiers and model results can be saved to the database. A model score can be determined as part of the model results; the model score can be stored independently or as part of the model results. Testing may continue until all test items have been processed.

After testing, the model training process 400 may perform threshold validation, at 412. During the threshold validation, targets for false positive and false negative results (e.g. a 0.5% false positive rate and 0.25% false negative rate can be used) may be retrieved from the database. The test set items, their model score, and expected result can also be retrieved from the database and ordered by model score in descending order. The list of test set items can be iterated through until an appropriate number of high scoring items with known negative answers to the question have been identified at which point a maximum threshold is set at the model result for that item. If there are 100,000 items in the test set and an allowed false positive rate of 0.5% this would continue counting until the score of the 500th item with a known answer of no. The score for that would be the upper threshold and any item scored higher than that would be returned by the system with an answer of yes.

Further, during threshold validation, at 412, a minimum threshold for detection of the information in the content can be validated. The list of test set items can be reversed in order and processed in order from smallest to largest score until an appropriate number of low scoring items with known positive answers to the question have been identified at which point a minimum threshold can be set at the model result for that question, which below the minimum threshold below there is considered to be definitively no detection of the information in the content.

The number of total items in the test set with a value above the upper threshold is added to the number of total items with values below the lower threshold and then divided by the total number of items in the test set to generate an expected accuracy of the model indicating the percentage of items submitted to which the model can be expected to give a definitive answer. If the calculated upper threshold is below the calculated lower threshold the model accuracy is listed as 0

(Modification for Neural Networks)—Unlike FA and HMM the Neural networks output two values, one indicating the maximum strength of the yes neuron the other indicating the maximum strength of the no neuron. For these models the check is made with the list order descending for both first ordering by the yes neuron output then the no neuron output. When calculating model accuracy items which have both neurons exhibiting values above their respective thresholds are rejected as ambiguous and deleted from the total.

When the thresholds have been determined, the model training process 400 may perform test set training, at 414. After the testing and validation are completed the test set corpus items can be processed through one or more, or all, of the training methods discussed below. Then, the final models can be saved to the database, at 416.

Referring to FIG. 5, a flowchart of a process of frequency analysis model training, in accordance with certain embodiments of the present disclosure, is shown and generally designated 500. The frequency analysis model training process 500 may be part of the process 200 and may be implemented by the system 100 or any other of the systems described herein.

The frequency analysis model training process 500 may include preparing a corpus, which may include splitting the corpus into two segments, a first segment and a second segment, at 502. The process 500 may also clear any existing models, at 504. Further, the process 500 may perform preprocessing for each corpus item in the first segment, at 506.

Frequency analysis training process 500 can include generating likelihood ratios for specified words, comparing the likelihood of seeing the word in content that matches a specific question versus content that does not, at 508-520. The training can count the total number of words in both positive and negative examples of the question, at 508, 510, and 512. For each word encountered in the training set, divide the number of times encountered in a positive example by the total number of words encountered in positive examples, at 516, and divide the number of times encountered in negative examples by the total number of words encountered in negative examples, at 514. The process 500 can then calculate the ratio of those two values, at 518, and save the results to a database, at 520.

In some embodiments, if a word has been encountered fewer than ten times in the entire corpus, the likelihood ratio can be set to one. Similarly, if a word has been encountered more than ten times in the entire corpus, but never in a negative example, the number of negative occurrences can be set to a non-zero value (such as five) in order to avoid a divide by zero error.

The process 500 may also include testing the results, at 522-532. Testing the results may include perform preprocessing for each corpus item in the second list, at 522. Then, the process 500 may include calculating the vector distance for the words in the second list, at 524. The process 500 may then include comparing the vector distance results to preset thresholds, at 526, and can also compare the results from the frequency analysis model to human analysis answers, at 528. Based on the comparisons, the process 500 can determine total correct percentage, total incorrect percentage, false positive percentage, false negative percentage, and percentage where threshold values are not exceeded, at 530. The results may be saved to a database, at 532. If any of the test results are not acceptable, the training model may be further trained or may clear the model to start training from scratch.

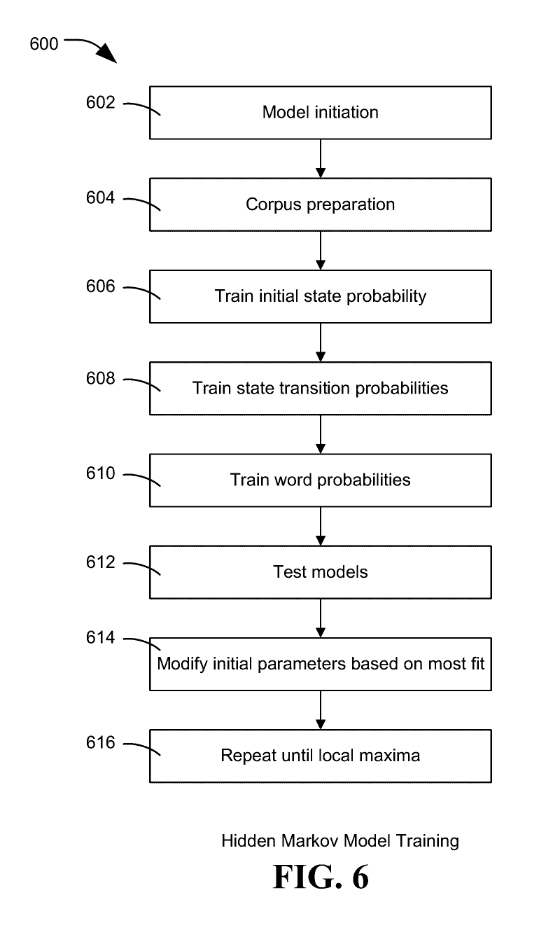

Referring to FIG. 6, a flowchart of a process of hidden Markov model training, in accordance with certain embodiments of the present disclosure, is shown and generally designated 600. The hidden Markov model training process 600 may be part of the process 200 and may be implemented by the system 100 or any other of the systems described herein.

The Hidden Markov model training process 600 can create a series of states, probability distributions, and state transition probabilities to define a system in which content that answers a question in a positive way will be more probable than content that answers the question in a negative way. The process 600 may start by performing a model initiation, such as generating a set number of states with each state consisting of a randomly generated initial probability, a randomly generated set of transition probabilities to other states (including itself) and a symbol distribution created by using the frequency distributions of words seen in the frequency analysis training. In addition, a Good-Turning algorithm can be used to generate an “unknown word” probability for words not previously encountered.

After model initialization a Baum-Welch analysis and update algorithm, or forward backward algorithm, can be used to update all three of the values for each state on each positive example of content which matches the question for which the model is being generated. For the purpose of the Hidden Markov Models each word in the corpus item may be considered a time step. The Baum-Welch algorithm can calculate the probability of starting in any state, advancing through the model while seeing the words in the corpus item, reaching a set state, and then transitioning either to another state or back to our initial state and seeing the remainder of the corpus item. The values calculated by this are used to update the model.

To avoid extremely low probabilities which could overwhelm the range of available data types, a normalization factor can be employed at each time step to normalize the values across all states to 1. A scaling factor can then be calculated as the product of all the non-normalized values at the time step which can be factored in to the model updates.

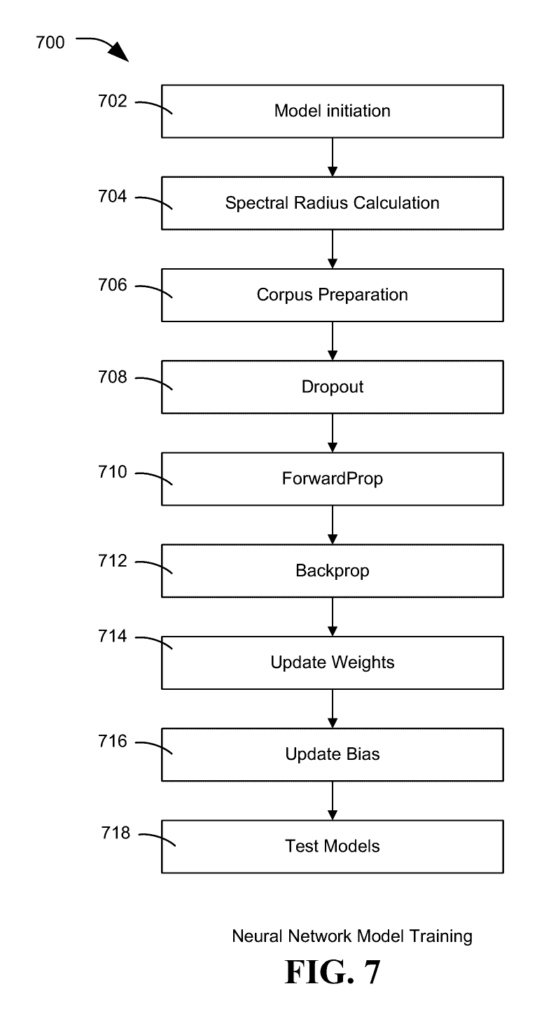

Referring to FIG. 7, a flowchart of a process of neural network model training, in accordance with certain embodiments of the present disclosure, is shown and generally designated 700. The frequency analysis model training process 700 may be part of the process 200 and may be implemented by the system 100 or any other of the systems described herein.

The neural network training process 700 can include a recurrent neural network(s) with deep learning for content analysis. The neural network can be initialized by generating a defined number of neurons in an input layer, a defined number of hidden layers, a defined number of neurons in each hidden layer, and a pair of output neurons, at 702. Each Neuron can be assigned a bias value randomly generated using a normal distribution with a mean of 0 and a standard deviation of 1. Connections are created between each layer and itself as well as each layer and the next in line, so all the neurons will have connections created to themselves as well as to all the neurons in the first hidden layer, all the neurons in the first hidden layer will be connected to themselves as well as the neurons in the second hidden layer and so on. The connections can be assigned weights from random numbers from a normal distribution with a mean of 0 and a standard deviation of 1/(the total number of neurons in the two layers being connected).

In some embodiments, in addition to being connected to the neurons in their layer and the next hidden layer, all hidden layers can be additionally connected to the output neurons.

After model initialization, the layer connections can be tested to ensure suitability and avoid gradient decay. The method for this testing is to define each pair of connected layers as a matrix of N×N, with N being the total number of neurons in the two layers and the values of the matrix being the connection weights between the neurons. The spectral radius of the matrix may then be calculated by taking the maximum of the absolute value of the eigenvalues for the matrix, at 704. This value can then be multiplied by 0.95 and each weight in the matrix is divided by the resultant value. The spectral radius can then be calculated again and is tested to confirm that it is now approximately equal to 1.05. The neuron connection weights are updated with the new weights.

For each corpus item being trained, a dropout algorithm can then be applied turning off 50% of the neurons in each layer at random, at 708. This can be accomplished by generating a list of the neurons to be disabled. After each layer activation, the neurons can be compared to the list of dropout neurons and any that match have their output forcibly reset to 0.

In some embodiments, the process 700 can include implementing a forward propagation algorithm, at 710. This can include performing training on each corpus item by feeding the inputs, calculated as a moving window of 300 dimensional vectors representing the words, into the input layer. For time step 1, words 1-7 can be fed, in time step 2 words 2-8, in time step 3 words 3-9, and so on until the end of the corpus item. The neural network can then be activated in layers with each neuron first calculating its input value by taking the sum of the output values of all connected neurons multiplied by the weight of the associated connection and then adding their bias value. The output value for the neuron can then be calculated by applying a sigmoid function to the input.

After the entire corpus item has been run through the forward propagation algorithm the error rate can be calculated for each timestamp and then fed into an inverted version of the neural network for performing a backward propagation, at 712. The error rate is calculated as the derivative of the difference between the output neurons and an expected value based off the known answer to the question for the corpus item. The layers are activated in reverse with all the connections reversed as well and values are calculated for each neuron and that value is multiplied by the output of the forward propagation for that neuron at the same time step. In the back propagation, the sigmoid function is not applied and so the value for the neuron is just the sum of its inputs times the associated connection weights. The changes made to the connection weights during the spectral radius calculation should protect the neural network from gradient decay where the values in back propagation drop to 0; however, gradient explosion, where they increase to infinity is still a risk as the target spectral radius was greater than 1. To resolve this risk, a technique of gradient clipping can be employed in which any values over a defined threshold trigger the values of the entire layer to be normalized to a value equal to that threshold.

Once forward propagation and back propagation have completed, the weight and bias values for the neural network can be updated, at 714 and 716, respectively. A training rate can be calculated by taking a defined starting weight and decaying it by a set percentage after each corpus item. Then, weight of each connection is set to the old weight, minus the learning rate times the sum of the products of the output values from the forward propagation algorithm for the starting neuron and the outputs of the back propagation algorithm for the destination neuron each time that connection was activated during the observation. The bias values can be updated to be equal to the old bias minus the learning rate times the sum of the output values for the neuron in the back propagation algorithm each time the neuron had a value. Because the back propagation multiplies its output by the forward propagation, any neurons targeted for dropout will have values of 0 for both. This will result in new weights and biases equal to the initial values. Finally, after all items have been trained, the weights of all connections are multiplied by the same percentage as neurons which have been disabled in dropout to calculate the final values for the resulting neural network model. The process 700 may also include testing the results by processing selected corpus items against the resulting neural network model, at 718.

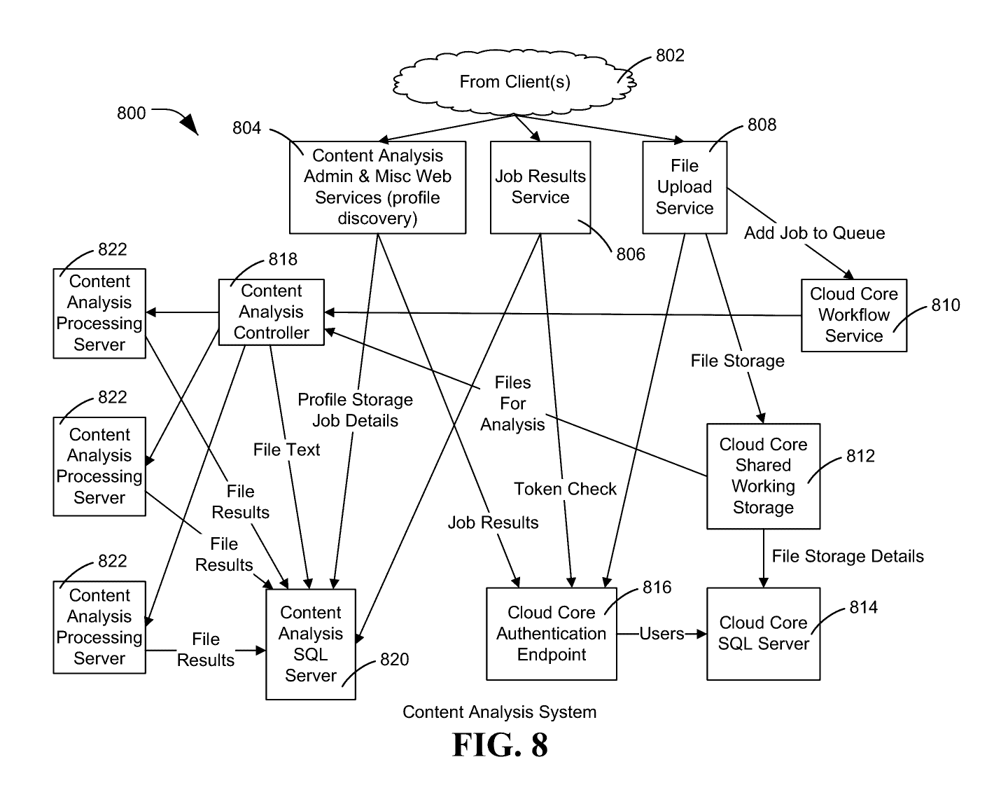

Referring to FIG. 8, a system of detecting information, in accordance with certain embodiments of the present disclosure, is shown and generally designated 800. The system 800 may be implemented by the system 100, or variations thereof. The system 800 can include an administration portal module (e.g. a GUI) 804, a job results module 806, and a file upload module 808 that may be communicatively coupled to a workflow service module 810. The workflow service module 810 may be communicatively coupled to a content analysis controller 818, which may be one or more processors at one or more servers. The file upload module 808 may also be communicatively coupled to a data storage server 812 and a database server 814, which may be an SQL server. An authentication endpoint 816 may be communicatively coupled to the administration portal module 804, the job results module 806, the file upload module 808, or any combination thereof.

The content analysis controller 818 may be communicatively coupled to content analysis processing servers 822 and may also be communicatively coupled to a content analysis database server 820, which may be an SQL server. The servers represented in the system 800 may any configuration of a server or multiple servers that can perform the functions described herein.

During operation, the system 800 can perform a file analysis process on one or more files to provide a result indicator to one or more clients via the network 802. The file analysis process may be initiated when a file or group of files are submitted for analysis through a web service, such as file upload service 808. The file upload service 808 may receive file parameters as an input and store the file parameters as metadata. The file parameters can include a byte stream of the file, a file name, an identifier for what profile of questions a client would like the file analyzed against, a job identifier (may be provided by the client or assigned), and a file identifier (may be provided by the client or assigned). In addition the web service can require authentication, such as via a security key or password, and the file upload service 808 can submit the provided authentication to the authentication endpoint 816 to determine whether the client is allowed to proceed. The authentication information received from the client may include a session token containing information on the identity of the client uploading the file. The file upload service 808 can save the file to working storage 812, which can save details of the file, including metadata and data pertaining to the file, to the database server 814. The file upload service 808 can also submit a job into a processing queue of the workflow service module 810, which may include information related to the job such as the location of the file, the identity of the uploader, and the parameters submitted.

The content analysis controller 818 can initiate a processing service by selecting a job out of the queue, which may be based on a first-in first-out process, a priority process, other arrangement, or any combination thereof. After a file is selected for processing, the file (including metadata and the file) may be received from the working storage 812 and provided to a memory associated with the content analysis controller 818. The content analysis controller 818 can then provide the file, or portions of the file, to the content analysis server(s) 822 for processing.

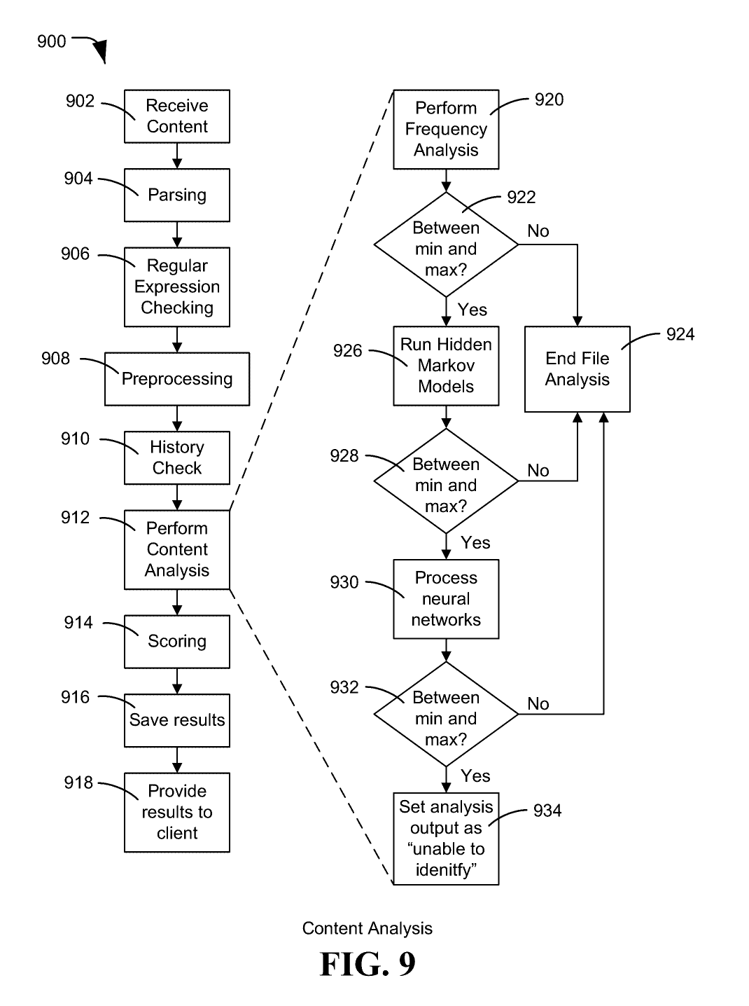

Once the content analysis processing server(s) 822 has the file, processing including parsing, regular expression checking, preprocessing, history checking, content analysis, and scoring, or any combination thereof, can be performed. For example, the content analysis processing server(s), in conjunction with the content analysis controller 818, may implement the process as shown and described with respect to FIG. 9. The results from the content analysis processing server(s) 822, which may include the scoring, can be saved to the content analysis database 820, which may be an SQL server.

A client can submit a request, via a web service such as a job results service module 806, to receive the results of the file analysis. The job results service module may accept parameters to identify a job and available options, such as a job identifier and a tag indicating if the client would like to receive full or summary results. The job results service module may also authenticate the client via authentication endpoint module 816, either before or after receiving the request to receive results of a file analysis. If the authentication indicates an identity which matches metadata associating a job with the client, then the file analysis results may be provided to the client. If the authentication does not match, the file analysis results may not be provided to the client. In some cases, a client may not be allowed to request file analysis results unless the client is authenticated prior to making a request.

When a client requests a summary as a result, the client may receive a formatted output, such as Java Script Object Notation. In some examples, the formatted output may contain an indicator of the total number of files received with a specific job identifier, an indicator of a number of files processed, an indicator of a number of files awaiting processing, and an indicator of an amount of time, such as in seconds, between arrival of a first file and when processing was completed for a final file. When a client requests a listing of full details as a result, the summary information may be provided and indicators of additional information may be appended to the full details results. The additional information may include a listing of each file associated with a specific job identifier including the file name, the file identifier, the score assigned by the content analysis processing server(s) 822, a range for the score indicating a level of detection of for the questions submitted to the system 800, the content types, and a count of matches for any client specified regular expression patterns. For example, an indicator of a range may identify whether no content of the requested type was identified, some content of the requested type was identified, or the system 800 could not make a determination. Further, the indicator of a range may identify whether a presence of detection information falls with a rating range such as a mild, moderate, or severe level of detection.

In certain embodiments, the system 800 may include an administration services module 804, which can allow a client to setup an account, modify settings, modify a profile, update information associated with job details, or similar functions.

Referring to FIG. 9, a flowchart of a process of content analysis, in accordance with certain embodiments of the present disclosure, is shown and generally designated 900. The process 900 may be implemented by the system 100, the system 800, or any other of the systems described herein. In certain embodiments, the process 900 may be implement natural language processing by the content analysis controller 818 and the content analysis processing server(s) 822, in conjunction with other elements of the system 800.

When a file has been selected for content analysis process, content such as the metadata and data of the file may be received, at 902. A file may be selected for content analysis processing based on a first-in first-processed selection, a priority selection, or other selection criteria. Once the content is received, the content may undergo parsing, at 904. In certain embodiments, one or more specific files may be uploaded to the system 800 through the file upload service module 808 and may be submitted to the content analysis process immediately, or nearly immediately; and, correspondingly, the results of such analysis may be provided to the requesting client as soon as possible.

During parsing, the file can be passed to a parser module and text can be extracted from the file. The extracted text can be separated into portions of a defined size, and may include a defined level of overlap between them (e.g. if the content is separated into chunks of 100 words with an overlap of 25, then the first chunk will include words 1-100, the second chunk will include words 75-175, and the third chunk will includes words 150-250, and so on). For example, spreadsheet files can be parsed as a list of key-value pairs for each row with the key being the content of the first row in the column and the value being the content of the column in the row being parsed. In another example, presentation slide files can be parsed with the text from each slide as a single portion.

When the parsing has completed, the file content may be processed for regular expressions, at 906. Regular expressions may be expressions specifically defined to be found in the content. For example, as part of a profile, a client may define regular expressions which the client would like the content checked against. There may also be other regular expressions defined that are not provided by the client, but are provided by other means of obtaining regular expressions (e.g. other users, other systems, machine learning, etc.). During regular expression checking, each portion of text can be evaluated against the regular expressions and an indicator of a total number of matches can be saved.

The method 900 may also include preprocessing, at 908. During preprocessing, each text portion can be filtered through a number of preprocessing steps, such as spelling check, replacing known patterns with identifiers through regular expression searching, stripping special characters, converting all words to lowercase, other processing steps, or any combination thereof. In certain embodiments implementing neural network(s), the words of the text portion can be replaced with dimensional vectors, (e.g. 300 dimensional vectors calculated using the Glove algorithm from Stanford OpenNLP Project) including a random vector defined for unknown words. The random vector for unknown words can be used for any words not in the database (e.g. a database in which there are precalculated vectors for the words in the database).

The method 900 may also include performing a history check, at 910, which may determine if the same content has been analyzed by the system before. For example, a hash of the content can be taken and compared to a hash of content which was previously analyzed by the system. If the hash value matches a hash value stored in the database, then the analysis results from the history can be used rather than re-processing the content.

The method 900 may also include performing content analysis, at 912, which can include natural language processing to identify matches of content in the text to questions relevant to the analysis. In certain embodiments, the content text can be natural language processed using a frequency analysis model, a hidden Markov model, a neural network model, other statistical models, or any combination thereof. The method 900 may also selectively apply the processing against selected models based on one or more thresholds.

For example, content text can be run against (i.e. processed via) frequency analysis models (e.g. there may be a model corresponding to each question) and first results can be computed, at 920; the first results may be compared to a minimum threshold and a maximum threshold, at 922. For any questions where the first results fall between the minimum threshold and the maximum threshold, the content text can be run against (i.e. processed via) the hidden Markov models to calculate second results, at 926. For any questions where both the first results and the second results are between the minimum threshold and the maximum threshold, at 928, the content can be run through (i.e. processed via) the neural network model(s) and a value of the output neurons can be determined to provide third results, at 930. The first results, second results, and third results may be used to determine the level of answer to the questions, which may include no information detected, mild amount of information detected, a moderate amount of information detected, or a severe amount of information detected. However, if all three results return values are between the minimum threshold and the maximum threshold, at 932, the answers to the questions may be ambiguous, and the content can be indicated or marked as “unable to identify”, or similar, indicating that detection of the information was undetermined, at 934. If during any of the threshold comparisons, at 922, 928, or 932, the results are not between the minimum and maximum thresholds, then the content analysis processing can end, at 924.

In certain embodiments, processing text against a frequency analysis model can be performed by separating the content into words, and determining a vector based on a ratio for each word from the model. The process can then calculate the Euclidian distance for that vector from the origin by taking the square root of the sum of all the values squared. To arrive at the final model result, the Euclidian distance value is divided by the total number of words.

In certain embodiments, processing text against a hidden Markov model can be performed by inputting the content into a hidden Markov model and calculating a forward value, such as can be accomplished based on the Baum-Welch algorithm. At each time-step, the values can be normalized to one and a scaling factor can be calculated by taking the natural log of the product of the unnormalized values. After the entire text has been processed, the scaling factors can be multiplied to create a final model result indicating the probability of seeing a specific sequence of words in a system defined by the word and state distributions of the trained model.

In certain embodiments, processing text against a neural network model can be performed by inputting a series of word vectors into the neural network in a seven word moving window similar to one used during training. The network can then be activated in layers with each neuron first calculating its input value by taking the sum of the output values of all connected neurons multiplied by the weight of the associated connection and then adding their bias value. The output value for the neuron can then be calculated by applying a sigmoid function to the input. The maximum value for the two output neurons can be calculated for the total time period of the content and is used as the output of the model.

The method 900 may also include performing scoring, at 914, which can include determining a score value for each portion of analyzed text. The scores for each portion of the file may be combined to generate a total score for a file. For example, for each portion of parsed content, the number of questions with an answer of yes can be multiplied by the sum of the weights of any questions for which the answer is yes; the scores generated for each portion can then be summed for all portions of a file to generate a total score for the file.

In certain embodiments, if all portions of content have a determination of no for all questions, then the final result for the file can be a score of 0 and indicate that no questions were detected. If any portions have a determination of yes for the file, then the final score can be the sum of those portion scores along with a descriptive level based on the score threshold. Further, if no portions of content have a determination of yes for the identified questions but some portions have an ambiguous determination, then the score can be −1, which can be an indicator that the system was unable to determine an answer for that file.

The method 900 may also include storing the results in a memory device, such as a database server, at 916, and providing access to the results to a client, at 918. If the results indicate that a detection level is inconclusive, a filestream associated with the inconclusive document may be deleted from a database that stores the file information. A filestream can be unstructured data stored in the database, and in some examples may be the text data corresponding to the document or a portion of the document. However, if any result is indicated other than inconclusive, then the filestream can be submitted to a model training system(s), such as those described herein, for addition of the filestream to the training corpus.

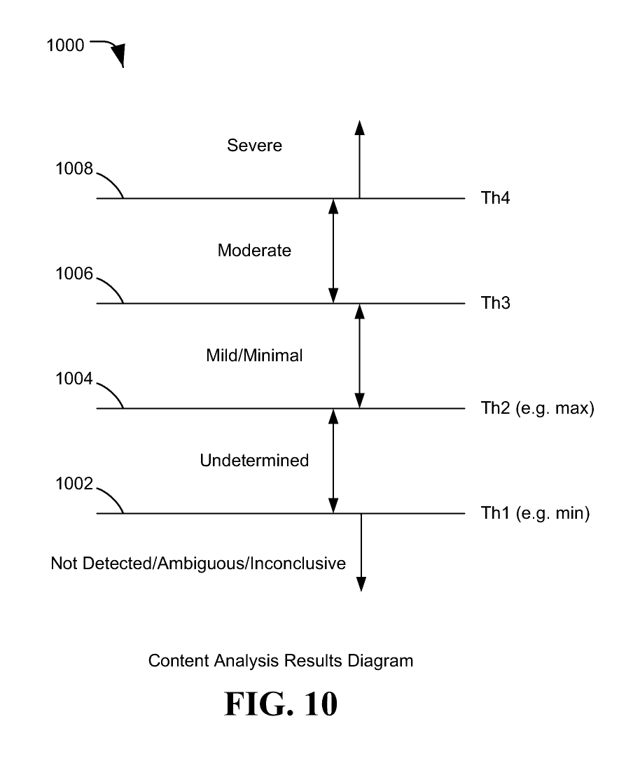

Referring to FIG. 10, is a diagram of detection levels in a process of content analysis, in accordance with certain embodiments of the present disclosure, is shown and generally designated 1000. The system 1000 may be implemented by the system 100, the system 800, the method 900, or any other of the systems or methods described herein. In certain embodiments, the system 1000 may be implemented by the content analysis controller 818 and the content analysis processing server(s) 822, in conjunction with other elements of the system 800.

The system 1000 may include a first threshold 1002, a second threshold 1004, a third threshold 1006, and a fourth threshold 1008. More or less thresholds may be included or removed from variations of the system 1000. The thresholds may each represent a value at which a decision point is made, such as in the content analysis process 900. The first threshold 1002 may be referred to as a minimum threshold and the second threshold 1004 may be referred to as a maximum threshold, and in certain embodiments, such correlate to the minimum and maximum values at which a content analysis system has undetermined information.

When used in conjunction with the content analysis process 900, the thresholds may be used to determine a detection level of information in a document. For example, a detection value below the first threshold 1002 can indicate that the information is not detected in the document. If the detection value is between the first threshold 1002 and the second threshold 1004, then the detection value can indicate detection of the information is undetermined or ambiguous. If the detection value is between the second threshold 1004 and the third threshold 1006, then the detection value can indicate detection of the information is a mild or minimal level of detection of the information in the document. If the detection value is between the third threshold 1006 and the fourth threshold 1008, then the detection value can indicate detection of the information is a medium or moderate level of detection of the information in the document. If the detection value is above the fourth threshold 1008, then the detection value can indicate detection of the information is a severe or high level of detection of the information in the document. Such detection levels may be applied for a portion of a document, a whole document, a group of multiple documents, or any combinations thereof.

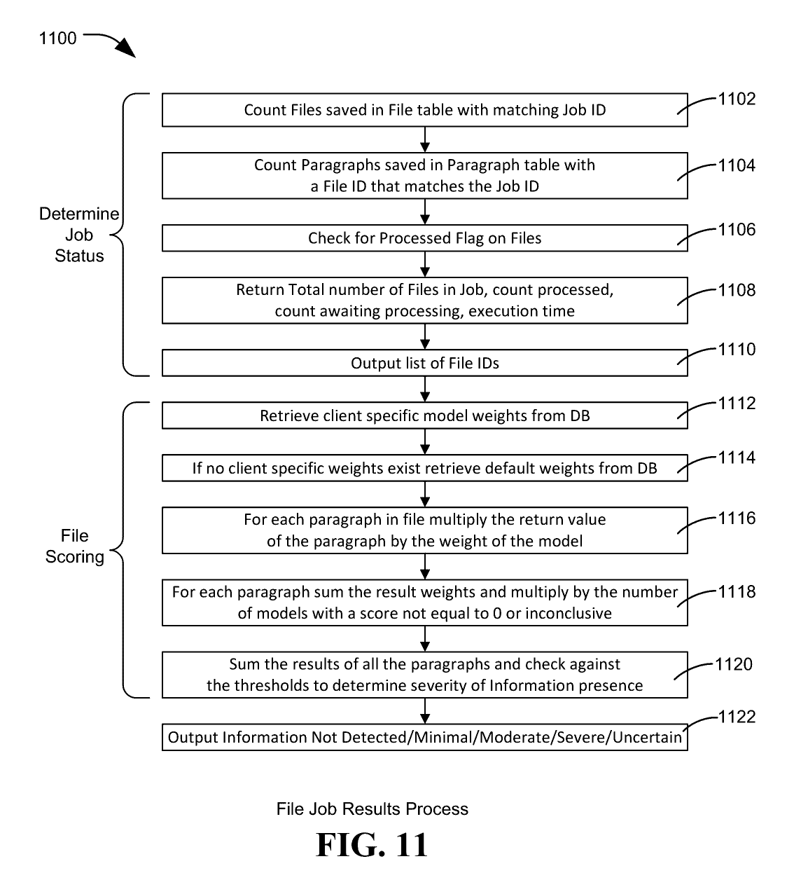

Referring to FIG. 11, a flowchart of a process of job results for a content analysis system, in accordance with certain embodiments of the present disclosure, is shown and generally designated 1100. The process 1100 may be implemented by the system 100, the system 800, or any other of the systems described herein.

The method 1100 may include determining a job status, performing file scoring, and outputting information to the requesting client based on the file scoring and job status. The method 1100 may be initiated when a client requests results from a processing job, or when content analysis for a processing job is finished, or at other times or triggers.

Determining a job status may include determining a count of files saved in a file table that have a matching job identification indicator or code, at 1102. Further, a count of paragraphs may be determined that are saved in a paragraph table with a file identifier that matches the job identification, at 1104. Then, determining the job status may include determining a status of processing for each of the paragraphs, each of the files, or any combination thereof, at 1106. The job status may be determined by retrieving an indicator, such as a processed flag, from a database for each of the files or paragraphs. The total number of files or paragraphs associated with a job, a count of files or paragraphs associated with a job that have been processed, a count of files or paragraphs associated with a job that are awaiting processing, and an execution time for processing may be determined, at 1108, based on data retrieved from one or more databases. A list of file identification indicators can be generated and provided to the client, at 1110, such as via a GUI or a messaging system.

Determining the file scoring may include retrieving client specific model weights from a database, at 1112. If no client specific model weights exist, the system may retrieve default weights from a database, at 1114. For each paragraph in a file, the process 1100 can multiply the returned value (i.e. score) of the paragraph by the weight associated with the model, at 1116. Then, the sum of the result weights for each paragraph can be calculated and multiplied by the number of models with a score not equal to 0 or inconclusive (e.g. above the maximum threshold to be ambiguous), at 1118, to generate a summed weighted value. Next, the method 1100 may sum all of the summed weighted values of all the paragraphs in a document to generate a score value and check the score value against the thresholds to determine a severity level of information presence, at 1120.

Once a score value indicating of a severity level of information detected is determined, the system may output (e.g. transmit) the information or an indicator to the client indicating the determined level of severity of the detected information, at 1122. The level of severity may indicate levels of severity for a single document, a group of documents, a portion of a document, or any combination thereof. For example, the client may receive an indicator of a severity level for a group of documents, and severity level indicators for individual documents therein may also be provided. This may allow a client to review grouped documents quickly and only review the individual document severity levels for selected groups of documents.

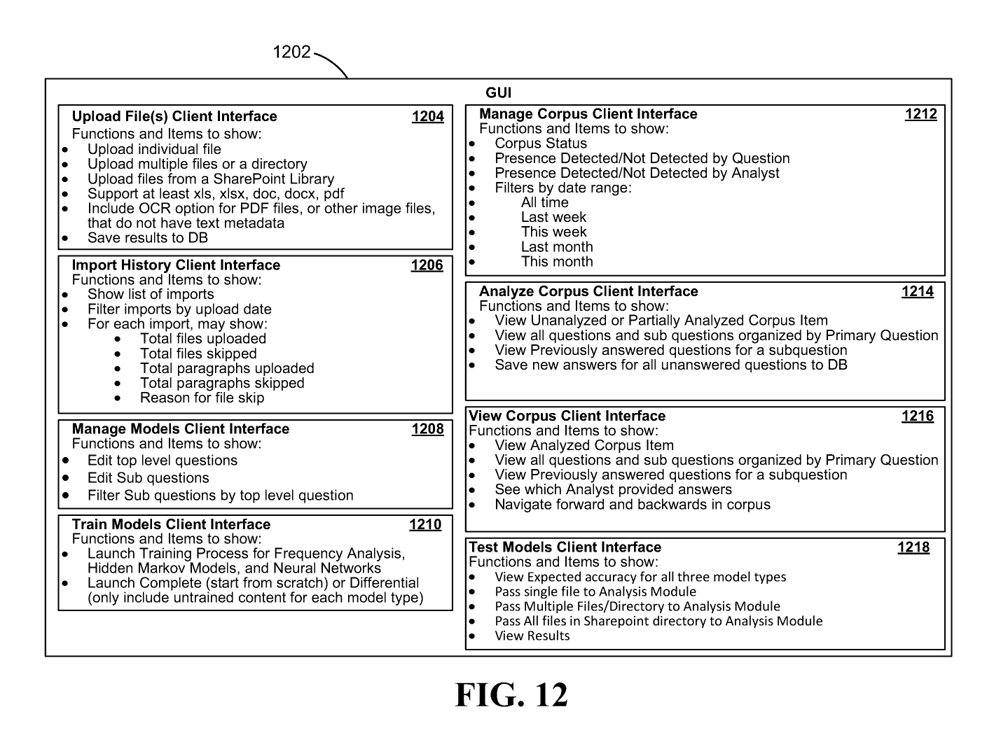

Referring to FIG. 12, a diagram of a graphical user interface (GUI) 1202 in a system of detecting information, in accordance with certain embodiments of the present disclosure, is shown. The GUI 1202 may be implemented by the system 100, the system 800, or variations thereof. The GUI 1202 may provide a client interface to allow a user to perform various functions and access various information pertaining to a system of detecting information. The options and features discussed herein may be provided through the GUI 1202 as forms, buttons, inputs, graphical icons, visual indicators, or other elements that allow direct user manipulation of graphical elements. In certain embodiments, the GUI 1202 may be replaced or accompanied by a command-line-interface.

For example, the GUI 1202 may include an upload file(s) client interface 1204, which may include any combination of the following items and functions: an option to upload an individual file, an option to upload multiple files or a directory, an option to upload files from a SharePoint library, an option to upload support at least XLS, XLSX, DOC, DOCX, PDF file types, an option to include optical character recognition (OCR) for PDF files or other image files that do not have text metadata, and an option to save results to a database.

The GUI 1202 may include an import history client interface 1206, which may include any combination of the following items and functions: show list of imports, filter imports by upload date. For each import, the GUI 1202 may show any combination of the following items and functions: an indicator of total files uploaded, an indicator of total files skipped, an indicator of total paragraphs uploaded, an indicator of total paragraphs skipped, and an indicator of a reason(s) for file skip.

The GUI 1202 may include a manage models client interface 1208, which may include any combination of the following items and functions: options to edit top level questions, options to edit sub questions, and options to filter sub questions by a top level question.

The GUI 1202 may include a train models client interface 1210, which may include any combination of the following items and functions: an option to launch training process for frequency analysis, an option to launch training process for hidden Markov models, an option to launch training process for neural networks, an option to launch training process for all of the training model types, an option to launch a complete training (start from scratch), and an option to launch a differential training (only include untrained content for each model type).

The GUI 1202 may include a Manage Corpus Client Interface 1212, which may include any combination of the following items and functions: an indicator of corpus status, an indicator of presence detected or not detected by question, an indicator of presence detected/not detected by analyst, an option to filter by date range, where the date range can include the following options: all time, last week, this week, last month, this month, a different time period, or any combination thereof.

The GUI 1202 may include an analyze corpus client interface 1214, which may include any combination of the following items and functions: an option to view unanalyzed or partially analyzed corpus item, an option to view all questions and sub questions organized by primary question, an option to view previously answered questions for a subquestion, and an option to save new answers for all unanswered questions to a database.

The GUI 1202 may include a view corpus client interface 1216, which may include any combination of the following items and functions: an option to view analyzed corpus item, an option to view all questions and sub questions organized by primary question, an option to view previously answered questions for a subquestion, an option to see which analyst provided answers, and an option to navigate forward and backwards in a corpus.

The GUI 1202 may include a test models client interface 1218, which may include any combination of the following items and functions: an option to view expected accuracy for all three model types, an option to pass a single file to the analysis module, an option to pass multiple files or contents of a directory to the analysis module, an option to pass all files in a Sharepoint directory to the analysis module, and an option to view results.

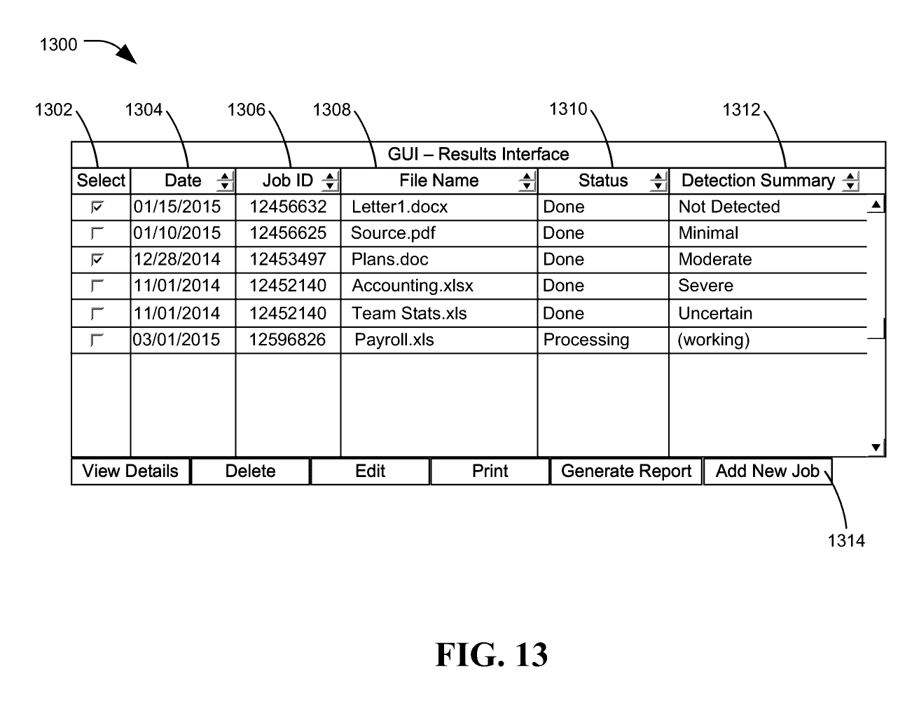

Referring to FIG. 13, a diagram of a graphical user interface (GUI) 1300 in a system of detecting information, in accordance with certain embodiments of the present disclosure, is shown. The GUI 1300 may be implemented by the system 100, the system 800, or variations thereof. The GUI 1300 may provide a client interface to allow a user to perform various functions and access various information pertaining to a system of detecting information. The options and features discussed herein may be provided through the GUI 1300 as forms, buttons, inputs, graphical icons, visual indicators, or other elements that allow direct user manipulation of graphical elements. In certain embodiments, the GUI 1300 may be replaced or accompanied by a command-line-interface.

In some embodiments, the GUI 1300 may display results of an information detection processing system, such as described herein. The results may include a date performed 1304, a job identification 1306, a file name 1308, a status 1310, and a detection summary 1312. In certain embodiments, the detection summary 1312 may include an indicator for multiple statuses, such as: not detected, minimal, moderate, severe, uncertain, and working; where various wording can be used to communicate such statuses. Further, the GUI 1300 may have a result selection option 1302 to allow a user to select a specific result and perform a corresponding function, such as view details, delete, edit, print, generate report, other functions, or any combination thereof. Further, the GUI 1300 may include a selectable option to add a new job 1314.

The processes, machines, and manufactures (and improvements thereof) described herein are particularly useful improvements for automated detection of specific information in documents and data files. Further, the embodiments and examples herein provide improvements in the technology of automated pattern recognition and automated word spotting. In addition, embodiments and examples herein provide improvements to the functioning of computer server(s) by automating information detection to allow massive amounts of documents to be quickly and accurately processed to detect certain information, thereby creating a specific purpose computer by adding such technology. While technical fields, descriptions, improvements, and advantages are discussed herein, these are not exhaustive and the embodiments and examples provided herein can apply to other technical fields, can provide further technical advantages, can provide for improvements to other technologies, and can provide other benefits to technology. Further, each of the embodiments and examples may include any one or more improvements, benefits and advantages presented herein.

The illustrations, examples, and embodiments described herein are intended to provide a general understanding of the structure of various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above examples, and other embodiments not specifically described herein, will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. A system comprising:
a network interface configured to send data to a client;
memory configured to store the data and store a software module;
a controller configured to execute the software module to perform a method including:
performing natural language processing on a selected set of documents;
detecting selected information in the selected set of documents; and
alerting the client about the selected information via the network interface.

2. The system of claim 1 further comprising the natural language processing includes performing binary classification against a list of predefined questions to produce a binary result.

3. The system of claim 2 further comprising the method includes detecting selected information in the documents includes determining a score, for each document, based on a frequency of occurrence of positive results of the predefined questions and weights for each predefined question in a specified content type.

4. The system of claim 2 further comprising the method includes performing the natural language processing to detect personally identifiable information.

5. The system of claim 4 further comprising the method includes:
each of the predefined questions is associated with a weight;
scoring a document based on a number of incidences of detected results for each predefined question and its associated weight to produce a score; and
assigning each score a first indicator representing no personally identifiable information was detected when a score is below a first threshold; and
assigning each score a second indicator representing some personally identifiable information was detected when the score is above a second threshold.

6. The system of claim 5 further comprising the method includes:
assigning each score a third indicator representing some personally identifiable information was detected when the score is above a third threshold;
assigning each score a fourth indicator representing some personally identifiable information was detected when the score is above a fourth threshold; and
transmitting an assigned indicator to the client, where a score above the fourth threshold indicates a severe detection level to the client, a score above the third threshold but below the fourth threshold indicates a medium detection level to the client, and a score above the second threshold but below the third threshold indicates a mild detection level to the client.

7. The system of claim 5 further comprising the method includes assigning each score a fifth indicator that detection of personally identifiable information was undetermined, where a score between the first threshold and the second threshold indicates an undetermined detection level.

8. The system of claim 4 further comprising the personally identifiable information includes information in context with which an individual without specialized expertise would be able to identify an individual.

9. The system of claim 4 further comprising the personally identifiable information includes at least one of a name, address, email address, phone number, government identification number, financial account information, and date of birth.

10. The system of claim 1, further comprising the natural language processing includes performing analysis of content of the selected set of documents by performing frequency analysis of the content, applying a hidden markov model to the content, and processing the content with a neural network.

11. A method comprising:
performing, automatically via a computer system, natural language processing on a selected set of documents;
detecting, automatically via the computer system, selected information in the documents; and
alerting a client about the selected information via the computer system.

12. The method of claim 11 further comprising the natural language processing includes performing binary classification against a list of predefined questions to produce a binary result.

13. The method of claim 12 further comprising detecting selected information in the documents includes automatically determining a score, for each document, based on a frequency of occurrence of positive results of the predefined questions and weights for each predefined question in a specified content type.

14. The method of claim 13 further comprising:
scoring a document based on a number of incidences of detected results for a predefined question to produce a score;
assigning a score a first indicator representing no personally identifiable information was detected when a score is below a first threshold; and
assigning a score a second indicator representing some personally identifiable information was detected when the score is above a second threshold.

15. The method of claim 11 further comprising:
scoring a document based on a number of incidences of detected results for each predefined question to produce a score, the predefined question producing the selected information;
determining a severity of a detection level of personally identifiable information in a document based on the score; and
transmitting an indicator of the severity of the detection level to the client.

16. The method of claim 15 further comprising determining the severity includes determining the detection level of personally identifiable information was undetermined.

17. A memory device including instructions, that when executed, cause a processor to perform a process comprising:
automatically performing natural language processing on a selected set of documents;
automatically detecting selected information in the documents; and
sending an alert to a client about the selected information via a network interface.

18. The memory device of claim 17 including instructions, that when executed, cause a processor to perform a process further comprising:
detecting selected information in the documents includes automatically determining a score, for each document, based on a frequency of occurrence of specific content.

19. The memory device of claim 17 including instructions, that when executed, cause a processor to perform a process further comprising:
scoring a document based on a number of incidences of detected results for specific content to produce a score;
determining a severity of a detection level of personally identifiable information in a document based on the score; and
transmitting an indicator of the severity of the detection level to the client.

20. The memory device of claim 17 including instructions, that when executed, cause a processor to perform a process further comprising:
providing a graphical user interface (GUI) to a client, the GUI showing indicators associated with the documents and detection results indicating a severity level of detections of the selected information.
